(19) United States
(12) Patent Application Publication
(10) Pub. No.: US 2014/0316834 A1
(43) Pub. Date: Oct. 23, 2014

(54) Milestone Management

(71) Applicant: CloudLogix, LLC, Denver, CO (US)

(72) Inventors: Robert K. Langhorne, III, Grapevine, TX (US); Robert K. Langhorne, IV, Denver, CO (US)

(21) Appl. No.: 14/254,752

(22) Filed: Apr. 16, 2014

Related U.S. Application Data
(60) Provisional application No. 61/812,948, filed on Apr. 17, 2013.

(51) Int. Cl. G06Q 10/06

(52) U.S. Cl. CPC G06Q 10/0631; G06Q 10/063114
USPC 705/7.15

(57) ABSTRACT

Various implementations described herein are directed to a non-transitory computer readable medium having stored thereon computer-executable instructions which, when executed by a computer, may cause the computer to receive information describing an event. The computer may perform a hierarchical fetch to retrieve a set of rules corresponding to the event. The computer may use the set of rules to create an interface. The computer may display the interface.

### CROSS-REFERENCE TO RELATED APPLICATIONS

This application claims the benefit of U.S. Provisional Patent Application Ser. No. 61/812,948, filed Apr. 17, 2013 and titled SUPPLY CHAIN SOFTWARE, the disclosure of which is incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Project management and scheduling is an important task in any organization. A project may be broken down into individual milestones that must be completed. Computer software may be used to aid in scheduling projects and completing milestones.

### SUMMARY

Described herein are implementations of various technologies for a method for receiving information describing an event and displaying an interface. In one implementation, a non-transitory computer-readable medium having stored thereon computer-executable instructions which, when executed by a computer, cause the computer to perform various actions. The actions may include receiving information describing an event. The actions may include performing a hierarchical fetch to retrieve a set of rules corresponding to the event. The actions may include using the set of rules to create an interface. The actions may also include displaying the interface.

Described herein are also implementations of various technologies for receiving information describing an event and using display rules and business rules to display an interface. In one implementation, a non-transitory computer-readable medium having stored thereon computer-executable instructions which, when executed by a computer, cause the computer to perform various actions. The actions may include receiving information describing an event. The actions may include retrieving display rules and business rules corresponding to the event. The actions may include using the display rules and the business rules to create an interface. The actions may also include displaying the interface.

Described herein are also implementations of various technologies for a method for managing one or more milestones. The method may include receiving information describing an event. The method may include creating the one or more milestones based on the event. The method may include retrieving a set of rules corresponding to the event using a hierarchical fetch. The method may include using the set of rules to create an interface corresponding to the one or more milestones. The method may also include displaying the interface.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a flow diagram of a method for milestone management in accordance with implementations of various techniques described herein.

FIG. 2 illustrates a flow diagram of a hierarchical rule fetch method in accordance with implementations of various techniques described herein.

FIG. 3 illustrates a swim lane diagram of supply chain milestones in accordance with implementations of various techniques described herein.

FIG. 4A illustrates a milestone input interface in accordance with various implementations described herein.

FIG. 4B illustrates an administrator overview interface in accordance with various implementations described herein.

FIG. 5A illustrates a message display interface in accordance with various implementations described herein.

FIG. 5B illustrates an order-specific message display interface in accordance with various implementations described herein.

FIG. 6 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

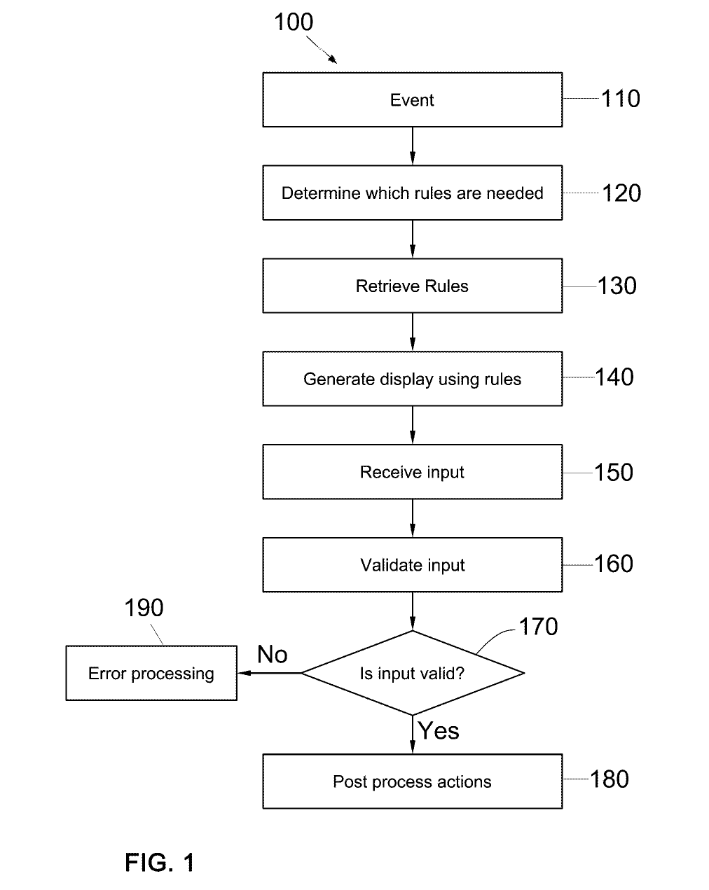

Various implementations for dynamic milestone management will now be described in more detail with reference to FIGS. 1-6.

The following paragraphs provide a brief overview of various implementations of dynamic milestone management. The milestone management software described herein may manage processes and milestones in any domain, and may have significant value when applied to a supply chain. When used in a supply chain, the milestone management software described herein may manage work flow and milestone-based supply chain processes, such as order management and management of customers, vendors, carriers, agents and suppliers. Additionally, the milestone management software described herein may enforce organization specific business rules, provide mechanisms for communication and approval processes of orders and shipments, and integrate with routing management to enforce shipping rules and to find the most cost effective shipping solutions. The milestone management software described herein may also including social networking features to allow users and customers to create, manage, and coordinate milestones, orders, shipments and operations.

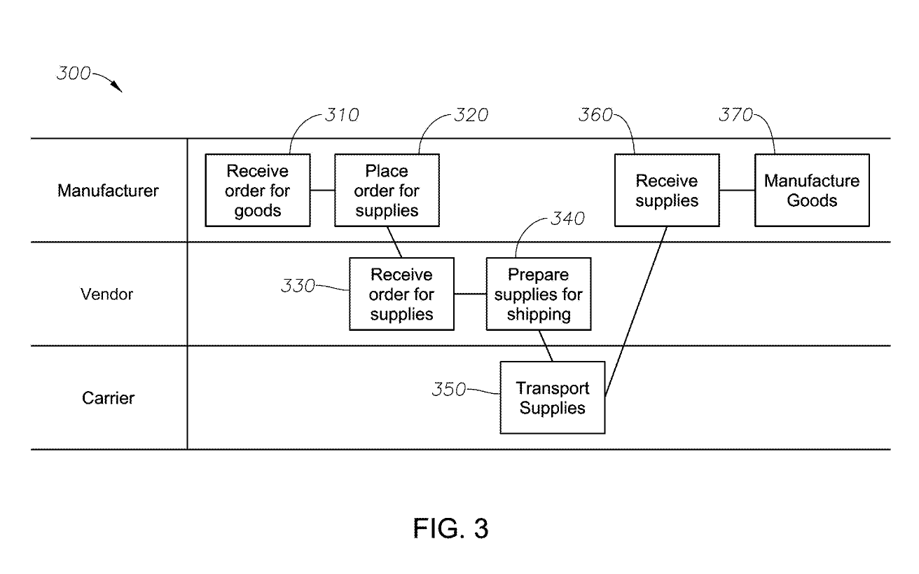

In one implementation, a cloud software service may be configured for dynamic milestone management. The cloud software service may implement milestone management method 100, described in FIG. 1. The cloud software service may have multiple users, and the users may be in different locations. For example, in FIG. 3, the cloud software service may receive data from and display interfaces for users at a manufacturer, vendor and carrier. The cloud software service may receive data through interfaces displayed to the users. The cloud software service may also receive data through other methods, for example, the service may be assigned an email inbox that can be used to receive and parse email messages.

FIG. 1 illustrates a flow diagram of a method 100 for milestone management in accordance with implementations of various techniques described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted.

At block 110, an event may occur, triggering the milestone management process 100. The event may be a business occurrence, the completion of a milestone, receiving user input, or any other occurrence. The events that trigger method 100 may be defined for an individual user, project, or organization. For example, a user logging in to a system may be an event that triggers method 100. In another example, a user may select a button on a user interface to indicate that a new order should be placed. Examples of events that may occur in a supply chain are further described in FIG. 3.

At block 120, method 100 may determine which rules are needed to process the event at block 110. Different types of events, users, organizations, or projects may require different types of rules. The rules may include display rules, flow rules, business rules, fulfillment rules, data rules, and notification rules.

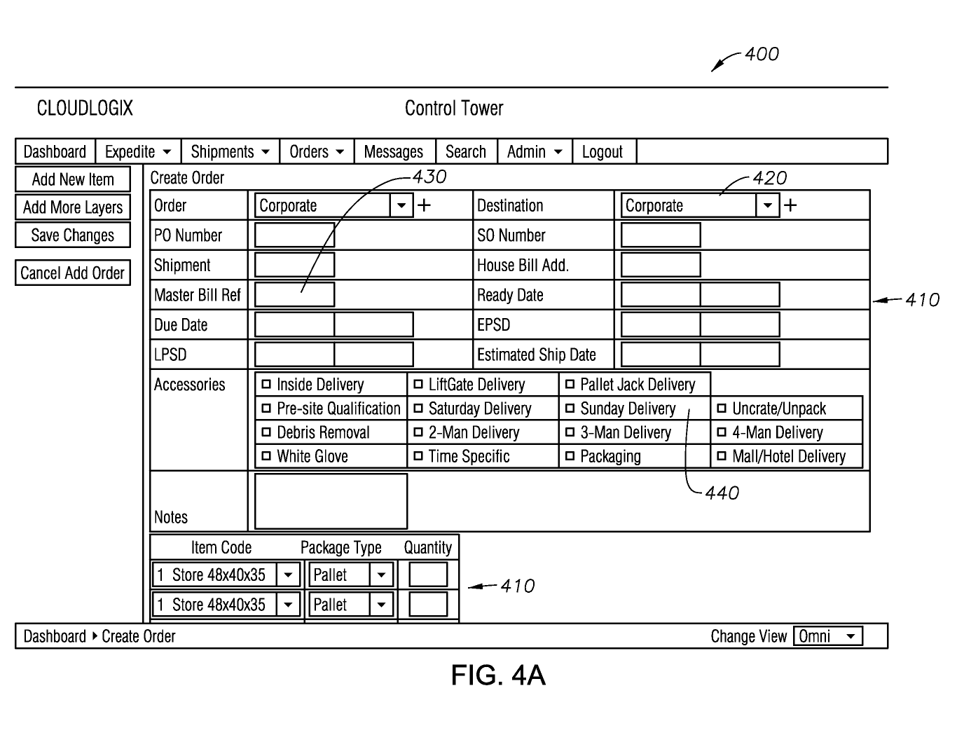

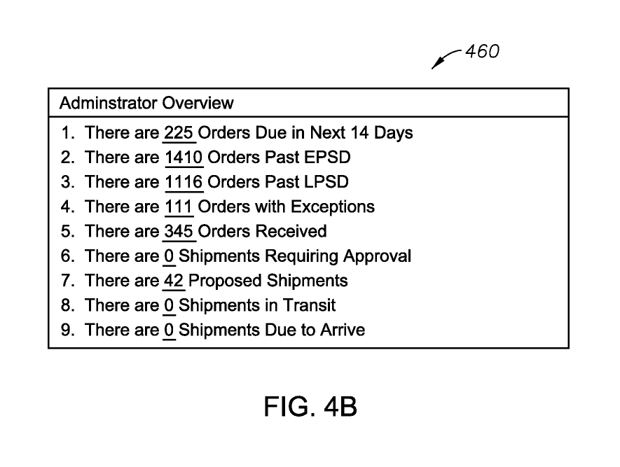

Display rules may include instructions describing the types of displays that should be created for a user while managing a milestone. FIGS. 4A and 4B are examples of displays that may be generated using display rules.

Flow rules may determine what should occur after the completion of a milestone. For example, after the completion of a first milestone, flow rules may determine the milestone that should be completed next. FIG. 3 is an example of a series of milestones in which flow rules may be used to determine the order in which the individual milestones are to be completed.

Business rules may be specific to an organization and may include organization specific requirements for business processes. For example, in one organization, business rules may dictate that an order cannot be shipped prior to two weeks before the last possible ship date for the order. In another example, business rules may dictate that a new customer cannot be entered without a phone number.

Fulfillment rules may detail the requirements for completing a milestone. For example, fulfillment rules may require a user to upload a document in order to complete a milestone.

Data rules may include instructions regarding how to parse or interpret data. For example, if a spreadsheet is input, data rules may detail where data in the spreadsheet should be stored.

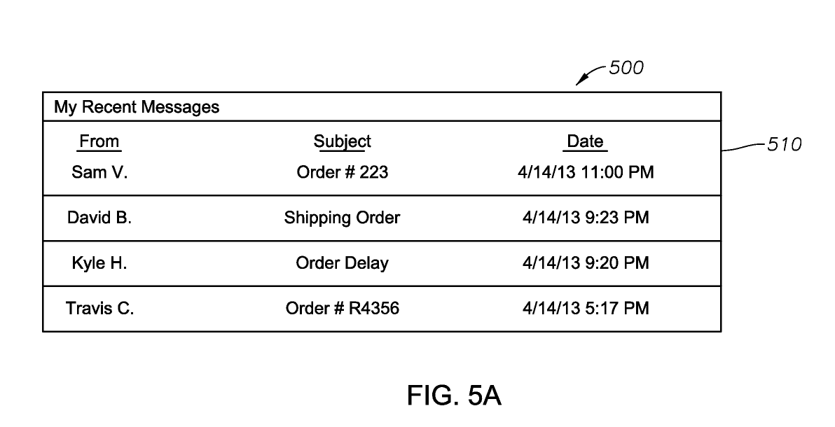

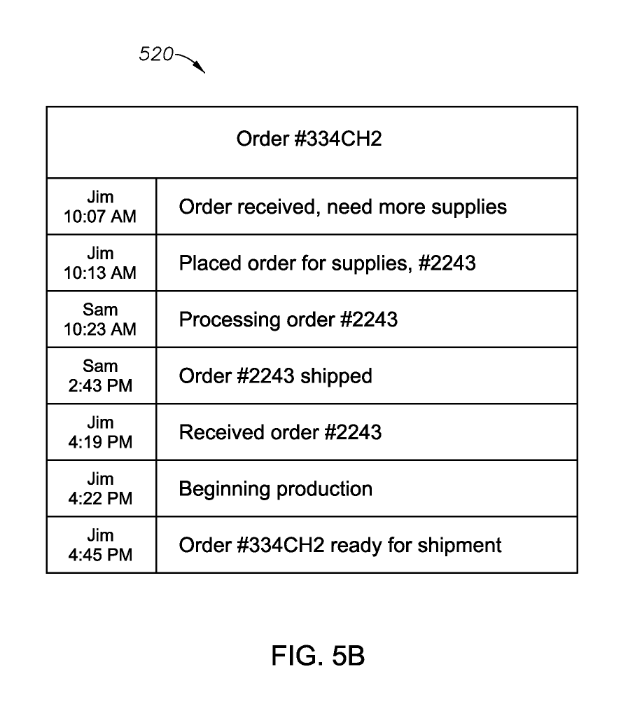

Notification rules may be used for social networking aspects of milestone management. For example, if an order is cancelled, notification rules may send a message to an administrator notifying the administrator of the cancellation. FIGS. 5A and 5B are examples of displays showing notifications that may be generated using notification rules.

In one example, if the event at block 110 is a user logging in to a system, method 100 will determine the display rules to be retrieved in order to generate a display for the user. In another example, if the event at block 110 is a new order being placed, method 100 will determine at block 120 the display rules to be retrieved in order to display an order entry interface, the fulfillment rules to be retrieved in order to validate the input entered using the interface, the notification rules to be retrieved in order to transmit a social networking message to an administrator stating that an order has occurred, and the data rules to be retrieved to determine where information contained within the order should be stored.

At block 130, once the particular rules have been determined, method 100 retrieves the rules needed to process the event. The retrieved rules may be display rules, flow rules, business rules, fulfillment rules, data rules, or notification rules, as determined in block 120. In one implementation, the rules may be organized in a hierarchical manner. The hierarchy may be, from the most specific to the broadest, event, user, role, project, site, customer, and client, where the customer is the client's customer.

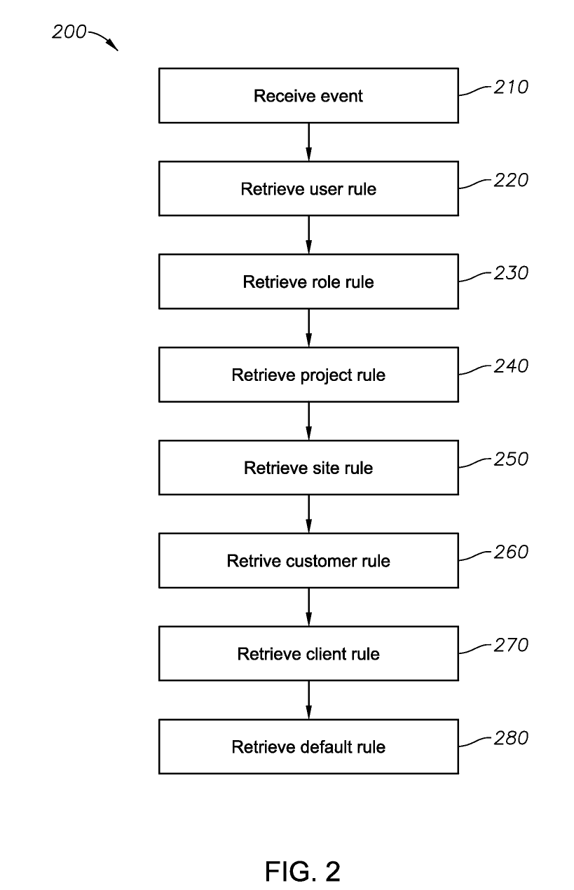

In one implementation, the rules may be retrieved using a hierarchical fetch, which is further described in FIG. 2 in more detail. The hierarchical fetch is configured to ultimately retrieve the most specific rule applicable to the event. Regardless of where the hierarchical fetch starts, i.e., most specific rule or broadest rule, the hierarchical fetch will ultimately retrieve the most specific rule.

For example, one installation of a cloud software service using method 100 may have one client with three different customers who each have two different projects, for a total of six different projects, and there may be different rules for each project and different rules for each customer. Method 100 is called to retrieve rules for an event associated with project X for customer Y. In this example, the broadest rule may be retrieved first. As such, the customer rules for customer Y may be retrieved first, and then the project rules for project X may be retrieved. If project rules exist for project X, then only the project rules are used as the rules for the event, but if project rules for project X do not exist, then the customer Y rules are used as the rules for the event. In this manner, the most specific rule is ultimately retrieved.

In another implementation, the retrieved rules at each hierarchical level may be combined. Using the same example, when retrieving rules for an event associated with project X and customer Y, the customer rules for customer Y and project rules for project X may be combined to form the set of rules used for the event.

The rules retrieved at block 130 may be customized based on how the milestone management method 100 is used. That is, the rules may be customized based on a variety of factors, e.g., the industry, the user's preferences, the user's client's preferences, the type of project, and the like. For example, a first user may use milestone management method 100 with a first set of rules for supply chain management, and a second user may use milestone management method 100 with a second set of rules to manage a software development process, which is a different application from supply chain management. Although the milestones that will occur and requirements for each milestone may be different for the first user and the second user, the same milestone management method 100, with two different sets of rules, may be used for both applications.

At block 140, a display may be generated based on the display rules that were retrieved at the previous step. In some implementations, other rules, e.g., flow rules, business rules, fulfillment rules, data rules, notification rules, etc., may be used to generate the display. The display rules may be applied to data from the event, data that is input, data that is retrieved, or combinations thereof. In one implementation, the display may include reports, spreadsheets, web pages or interfaces. In another implementation, at block 140, notifications, emails or text messages may be generated and transmitted according to the display rules and notification rules. FIGS. 4A and 4B illustrate examples of interfaces that may be generated at block 140 using display rules. For example, if the event at 110 is a selection indicating that a new order should be placed, FIG. 4A may be displayed at block 140. The interfaces generated at block 140 may allow a user to input information, including text, spreadsheets, documents, images, or any other type of input. For example, in FIG. 4A, a user may enter information corresponding to a new order, including shipping number, ship date, Purchase Order (PO) number, and other information describing the new order.

At block 150, method 100 may receive input. In one implementation, method 100 may receive input using a form generated at block 140. For example, FIG. 4A may be displayed, and a user may enter input using the forms in FIG. 4A. In another implementation, method 100 may receive a spreadsheet and use data rules to extract input data from the spreadsheet. The input received at block 150 may include data corresponding to the completion of a milestone. For example, if the milestone to be completed is “ship goods,” the input may be a tracking number of the shipped goods and an image of a packing slip, thus confirming that the goods have been shipped and that the milestone is complete.

At block 160, method 100 may validate the input received at block 150. Method 100 may use fulfillment rules and business rules to validate the input. Fulfillment rules may be used to determine whether all information required to complete a milestone was input. Business rules may be used to determine whether the input is consistent with the rules used by an organization. For example, in an organization that requires all orders over a given price to be approved by an administrator, the business rules may determine whether the approval is necessary and whether the approval has been received. In another example, if FIG. 4A is displayed at block 140, and input is received from FIG. 4A at block 150, fulfillment rules may be used at block 160 to determine whether all of the required information to place a new order is included in the input.

At block 170, method 100 may determine whether the input was validated or not, and if not, error processing may occur at block 190. During error processing at block 190, a user may be notified that an error has occurred. Additionally, error processing may describe the missing information or the cause of the error. Additionally, the user may be able to correct the error at block 190. In one example, form 400 in FIG. 4A is displayed at block 140, input is received at block 150 from the form 400 but the input received at block 150 does not include a PO number. The input may then be found to be invalid at block 160 based on the fulfillment rules retrieved at block 130. Error processing at block 190 may allow a user to complete form 400, by entering a PO number, and the method may then proceed to block 180.

If the input is validated, method 100 may proceed to block 180. At block 180, post process actions may occur. In one implementation, flow rules may be used to determine the post process actions. For example, if the milestone being completed in blocks 110-170 is entering a new order, the post process actions at 180 may include generating another milestone in which the order must be packed. FIG. 3 illustrates an example of a series of milestones that may be completed, where the next milestone is determined using flow rules. Additionally, notification rules may be used to generate social notifications after a process has completed. Post process actions may also include the generation of reports.

FIG. 2 illustrates a hierarchical rule fetch method 200 in accordance with implementations of various techniques described herein. It should be understood that while the operational flow diagram indicates a particular order of execution of the operations, in other implementations, the operations might be executed in a different order. Further, in some implementations, additional operations or blocks may be added to the method. Likewise, some operations or blocks may be omitted.

Hierarchical rule fetch 200 may be used to retrieve rules at block 130 in FIG. 1. Hierarchical rule fetch 200 may receive an event and then traverse a set of rules to find the rules applicable to the event. The traversed set of rules may include display rules, flow rules, business rules, fulfillment rules, data rules, notification rules, or any other rules. Hierarchical rules may be indexed using any hierarchy. In one implementation, the hierarchy may be, from broadest to most specific, client specific rules, customer specific rules, site specific rules, project specific rules, role specific rules, and user specific rules. At block 210, the hierarchical rule fetch method 200 may receive an event. The hierarchical rule fetch method may then extract or determine the hierarchical information for the event. That is, the method may determine the user, role, project, site, customer, and client associated with the event, or some subset of that information. For example, if the event is a new order being placed, the method may determine which client the order was placed at, which customer placed the order, and which project the order is for.

After determining or retrieving the hierarchical information for the received event, method 200 may retrieve the rules corresponding to the event. In one implementation, a filter may be created using the hierarchical information for the event. The filter may then be applied to a database of rules to retrieve the rules corresponding to the event. For example, the filter may be a database query created using the hierarchical information for an event.

The hierarchical fetch may proceed from most specific rule, at block 220, to broadest, at block 280. At block 220, method 200 may attempt to retrieve the user specific rules. If user specific rules exist, then method 200 will retrieve the user specific rules and method 200 is complete. If not, method 200 may attempt to retrieve role specific rules at block 230. If role specific rules exist, then method 200 will retrieve the role specific rules and method 200 is complete. If not, method 200 may attempt to retrieve project specific rules at block 240. If project specific rules exist, then method 200 will retrieve the project specific rules and method 200 is complete. If not, method 200 may attempt to retrieve site specific rules at block 250. If site specific rules exist, then method 200 will retrieve the site specific rules and method 200 is complete. If not, method 200 may attempt to retrieve customer specific rules at block 260. If customer specific rules exist, then method 200 will retrieve the customer specific rules and method 200 is complete. If not, method 200 may attempt to retrieve client specific rules at block 270. If client specific rules exist, then method 200 will retrieve the client specific rules and method 200 is complete. If not, the method may retrieve default rules at block 280.

In another implementation, hierarchical fetch method 200 may begin at the broadest rules and proceed to the most specific rules. For example, the fetch may first retrieve the default rules. Then, the fetch may retrieve the client rules. If client rules exist, the client rules will supersede the default rules. So, the client rules would be the rules used, not the default rules. Then, the method may retrieve the customer rules. If customer rules exist, the customer rules would supersede the client rules and the default rules. This process may continue until the most specific hierarchy has been reached.

In one implementation, at block 210, the method may extract the most specific hierarchical information from the event, and then use external information to determine the remaining hierarchical information for the event. For example, the method may extract the project information for an event. The method may then retrieve data from a database, where the data indicates that the project is assigned to a specific customer and client. Thus, the method may then know that the customer, client, and project corresponding to the event.

FIG. 3 illustrates a swim lane diagram 300 of supply chain milestones in accordance with implementations of various techniques described herein. Each milestone in the diagram 300 is managed using milestone management method 100. At each milestone in diagram 300, milestone management method 100 may be used to complete the milestone and transition to the following milestone. Users at Manufacturer, Vendor, and Carrier may access a cloud software service that implements milestone management method 100 to complete the individual milestones illustrated in FIG. 3. Although the process illustrated in FIG. 3 is linear, in some implementations milestones may occur simultaneously. For example, Vendor could receive one order for supplies, where the supplies are located in two different warehouses. Two milestones could then be generated and completed at the same time, a “prepare supplies for shipping” milestone for the first warehouse, and a “prepare supplies for shipping” milestone for the second warehouse.

The supply chain illustrated in diagram 300 contains milestones for Manufacturer, Vendor, and Carrier, which are organizations that play a role in the supply chain illustrated in diagram 300. In this example, Manufacturer receives an order for goods from one of Manufacturer's clients. Manufacturer examines the order and determines that the order cannot be manufactured without purchasing more supplies from Vendor. Manufacturer then places an order with Vendor for supplies. Vendor receives the order and prepares the order for shipping. Vendor then ships the order using Carrier. Carrier transports the supplies from Vendor to Manufacturer. Manufacturer receives the supplies, and then Manufacturer manufactures the goods that were ordered. The supply chain illustrated in diagram 300 will now be explained in more detail below.

At milestone 310, Manufacturer receives an order for goods from one of Manufacturer's clients, which is an event that may trigger milestone management method 100. Then, rules may be retrieved for the order. The retrieved rules may be used in combination with information extracted from the event to generate a report on the availability of all supplies required to manufacture the goods. Business rules may be used to determine that Manufacturer does not have sufficient supplies to complete the order for goods. During the post process actions at block 180, flow rules may dictate that, because more supplies are needed, the next milestone should be placing an order for supplies.

The completion of milestone 310 may be an event that triggers milestone 320. At milestone 320, Manufacturer places an order for supplies. Display rules may be used at 320 to generate an interface for a user to input information regarding an order for supplies. For example, the display rules may create a form in which a user may input an order number, a price, a quantity, and an estimated time of arrival for the supplies. Once the information is entered, the fulfillment rules may be used to determine that all required information has been entered, and the data rules may be used to determine where the entered information should be stored.

After Manufacturer places an order, thereby completing milestone 320, Vendor may receive the placed order for supplies at milestone 330. The order for supplies may be received in a digital format and parsed by data rules. For example, the order for supplies may be received in an email message that is automatically parsed, thereby retrieving the order information from the email message. The input may then be validated using the data rules, fulfillment rules, and business rules. Finally, flow rules may be used to determine that the next milestone to be completed is preparing supplies for shipping, thereby creating milestone 340.

At milestone 340, Vendor may prepare supplies for shipping. Display rules may be used to create a display for Vendor that states the products and quantities of those products to pack for shipping. Display rules may also be used to create a form in which Vendor will enter information regarding the shipment, such as a packing slip, tracking number, or any other information regarding the shipment. Once the supplies are prepared for shipment and the user enters the information, fulfillment rules may be used to determine whether all of the necessary information regarding the shipment has been entered in the system. Then, flow rules may be used to transmit information regarding the shipment to the Carrier. Additionally, notification rules may be used to generate an order confirmation message, which will be transmitted to the message inbox of an administrator at Manufacturer.

Once the supplies are prepared for shipping, the next milestone to complete is transporting the supplies from Vendor to Manufacturer. Carrier will complete this milestone at 350. To complete this milestone, a user employed by Carrier may transmit an email containing an image of a signed delivery confirmation form and a spreadsheet to an email inbox controlled by the cloud software service implementing milestone management method 100. Data rules may be applied to the received email to store the information. Fulfillment rules may be used to determine that the milestone has been completed. Notification rules may be used to transmit a notification describing the completion of the milestone at 350 to Manufacturer. For example, an email may be sent to Manufacturer with details regarding the shipment of supplies.

At block 360, Manufacturer completes a milestone correlated to receiving the supplies. Display rules may be processed to create a form in which Manufacturer may confirm that the shipment contains all of the supplies ordered at block 320. Business rules may be used to determine where the supplies should be stored, and display rules may be used to generate a display with instructions detailing where the supplies are to be stored. Then, fulfillment rules may be used to confirm that all of the proper data has been entered, and flow rules may be used to determine that manufacturing goods is the next milestone to be completed. Notification rules may be used to transmit a message to an administrator at Manufacturer stating that the supplies have been received, and that all supplies necessary for manufacturing the goods are now available.

Flow rules at block 360 dictate that the next milestone is manufacturing goods at block 370. Display rules at block 370 may be used to create a display that includes all of the information necessary for manufacturing the goods. The display may include information from the order received at block 310. For example, data rules may have been used to store data received at block 310 in a database, and data rules may be used at block 370 to retrieve that data from the database. A form may be created using the display rules that allows a user at Manufacturer to confirm that the goods have been manufactured. In this supply chain example, block 370 is the final milestone; however, in other implementations, flow rules may determine that another milestone is to be completed next.

The milestones in diagram 300 illustrate one example of a process in which method 100 may be used to manage a series of milestones using a set of rules. Although the milestones in diagram 300 describe a supply chain, milestone method 100 may be configured, using rules, to manage any series of milestones.

FIG. 4A illustrates a milestone input interface 400 in accordance with various implementations described herein. Milestone input interface 400 is an example of an interface that may be generated by method 100 using display rules at block 140 in FIG. 1. For example, the display rules retrieved at block 130 may contain instructions for method 100 to generate two tables 410. The rules may instruct method 100 to generate an interface with dropdown lists 420, text input boxes 430, and checkboxes 440. Other types of user interfaces may be displayed as well. The interface 400 may be completely dynamic. For example, every element in the interface 400 may be generated using rules. Once data has been entered into interface 400, the data may be validated using fulfillment rules and business rules, and stored using data rules.

FIG. 4B illustrates an administrator overview interface 460 in accordance with various implementations described herein. FIG. 4B, like FIG. 4A, may be generated using display rules. In one example, a user may login to a cloud system, which is an event that triggers the creation of the interface 460. In the interface 460, display rules may include instructions to create a table listing information relevant to an administrator. The administrator may select information within the interface 460 by clicking on the text, and additional information corresponding to the selection may then be displayed. To generate the interface 460, data rules may be used to retrieve data for the display. For example, data may be retrieved from a database, and then user interface 460 may be created, which contains the retrieved data.

FIG. 5A illustrates a message display interface 500 in accordance with various implementations described herein. The interface 500 may display messages received by a user. For example, in FIG. 3, an administrator at Manufacturer could receive the messages shown in FIG. 5A. Messages may be automatically generated using notification rules. Users using an interface may also create messages, and the messages may then be transmitted to another user. Messages shown in interface 500 may provide a way for different users responsible for milestones to communicate.

Messages may be used to provide users with information or reminders regarding milestones. Messages may be used to notify a user of information that requires attention. In a first example, in interface 500, a message from Kyle H. contains information regarding an order delay. Kyle H. may be an employee at Carrier who entered information describing the completion of a shipping milestone. The entered information may have included information corresponding to a shipping delay. Method 100 may have used notification rules to detect the delay and determine that a notification should be generated, and then a notification may have been generated and transmitted, resulting in the message being displayed in interface 500. Alternatively, Kyle H. may have manually noted that a delay would occur and then completed a message creation form in order to transmit a message regarding the delay, resulting in the message being displayed in interface 500.

FIG. 5B illustrates an order-specific message display interface 520 in accordance with various implementations described herein. The messages displayed in order-specific message display interface 520 are all related to a single order. In this example, the messages are related to the order for goods described in diagram 300 of FIG. 3. At block 310, Jim, a user employed at Manufacturer who receives the order for goods and determines that more supplies are needed, sent a message including that information. Jim then sent another message at block 320 to state that the order for supplies was placed, and that the order number is 2243. Sam, a user employed at Vendor, sends a message at block 330 stating that the order for supplies number 2243 is being processed. Sam then sends another message confirming that the order for supplies number 2243 has been shipped.

At block 360, Jim sends a message confirming that the order for supplies number 2243 has been received, and at block 370 Jim sends a message stating that production on the order for goods has begun. Jim sends a final message once production is complete, stating that the order for goods is ready for shipment. The message display interface 520 may allow a user to quickly view all messages relevant to an order. The interface 520 may be sorted by time sent, time received, relevance, whether or not a message has been read, or using any other factor. Although the interface 520 displays messages relevant to an order, the interface 520 may display messages relevant to a milestone, a user, a project, or any other criteria.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments, including a cloud computing environment, where tasks are performed by remote processing devices that are linked through a communications network, e.g., by hardwired links, wireless links, or combinations thereof. In a distributed computing environment, program modules may be located in both local and remote computer storage media including memory storage devices.

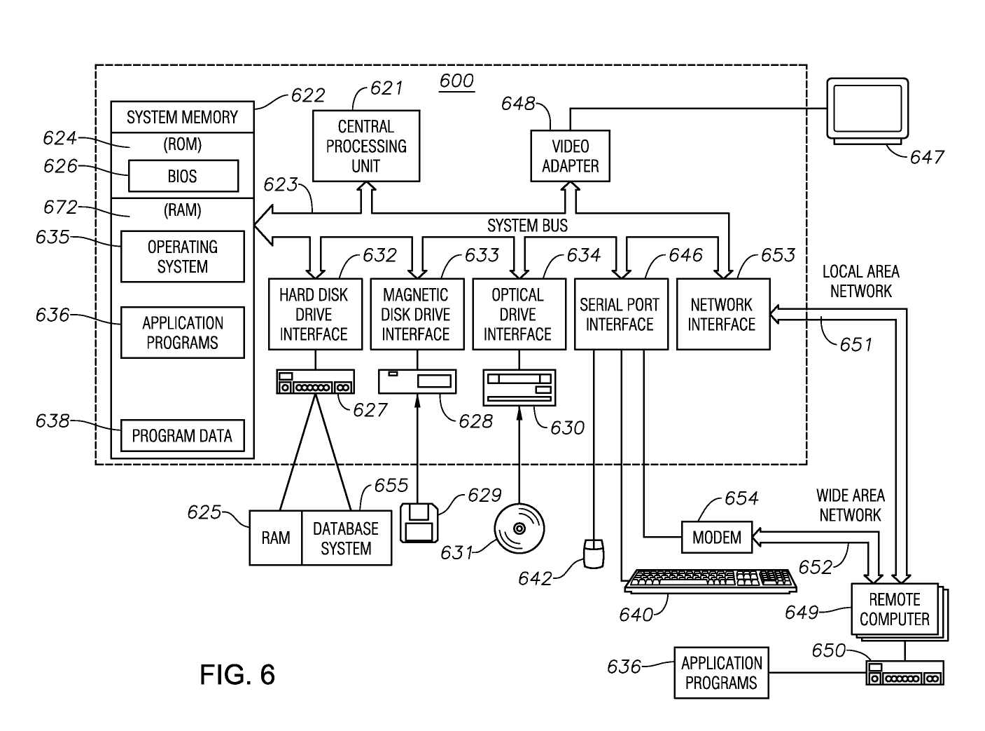

FIG. 6 illustrates a computer system 600 into which implementations of various technologies and techniques described herein may be implemented. Computing system 600 may be a conventional desktop, a server computer, a laptop, a tablet, or part of a cloud computing system. It should be noted, however, that other computer system configurations may be used.

The computing system 600 may include a central processing unit (CPU) 621, a system memory 622 and a system bus 623 that couples various system components including the system memory 622 to the CPU 621. Although only one CPU is illustrated in FIG. 6, it should be understood that in some implementations the computing system 600 may include more than one CPU. The system bus 623 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 622 may include a read only memory (ROM) 624 and a random access memory (RAM) 625. A basic input/output system (BIOS) 626, containing the basic routines that help transfer information between elements within the computing system 600, such as during start-up, may be stored in the ROM 624. The computing system may be implemented using a printed circuit board containing various components including processing units, data storage memory, and connectors.

The computing system 600 may further include a hard disk drive 627 for reading from and writing to a hard disk, a magnetic disk drive 628 for reading from and writing to a removable magnetic disk 629, and an optical disk drive 630 for reading from and writing to a removable optical disk 631, such as a CD ROM or other optical media. The hard disk drive 627, the magnetic disk drive 628, and the optical disk drive 630 may be connected to the system bus 623 by a hard disk drive interface 632, a magnetic disk drive interface 633, and an optical drive interface 634, respectively. The drives and their associated computer-readable media may provide nonvolatile storage of computer-readable instructions, data structures, program modules and other data for the computing system 600.

Although the computing system 600 is described herein as having a hard disk, a removable magnetic disk 629 and a removable optical disk 631, it should be appreciated by those skilled in the art that the computing system 600 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 600. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 627, magnetic disk 629, optical disk 631, ROM 624 or RAM 625, including an operating system 635, one or more application programs 636, program data 638, and a database system 655. The one or more application programs 636 may contain program instructions configured to perform methods 100 or 200 according to various implementations described herein. The operating system 635 may be any suitable operating system that may control the operation of a networked personal or server computer, such as Windows® XP, Mac OS® X, Unix-variants (e.g., Linux® and BSD®), and the like.

A user may enter commands and information into the computing system 600 through input devices such as a keyboard 640 and pointing device 642. Other input devices may include a microphone, joystick, game pad, satellite dish, scanner, user input button, or the like. These and other input devices may be connected to the CPU 621 through a serial port interface 646 coupled to system bus 623, but may be connected by other interfaces, such as a parallel port, game port or a universal serial bus (USB). A monitor 647 or other type of display device may also be connected to system bus 623 via an interface, such as a video adapter 648. In addition to the monitor 647, the computing system 600 may further include other peripheral output devices such as speakers and printers.

Further, the computing system 600 may operate in a networked environment using logical connections to one or more remote computers 649. The logical connections may be any connection that is commonplace in offices, enterprise-wide computer networks, intranets, and the Internet, such as local area network (LAN) 651 and a wide area network (WAN) 652. The remote computers 649 may each include application programs 636 similar to that as described above.

When using a LAN networking environment, the computing system 600 may be connected to the local network 651 through a network interface or adapter 653. When used in a WAN networking environment, the computing system 600 may include a modem 654, wireless router or other means for establishing communication over a wide area network 652, such as the Internet. The modem 654, which may be internal or external, may be connected to the system bus 623 via the serial port interface 646. In a networked environment, program modules depicted relative to the computing system 600, or portions thereof, may be stored in a remote memory storage device 650. It will be appreciated that the network connections shown are exemplary and other means of establishing a communications link between the computers may be used.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon computer-executable instructions which, when executed by a computer, cause the computer to:
receive information describing an event;
perform a hierarchical fetch to retrieve a set of rules corresponding to the event;
use the set of rules to create an interface; and
display the interface.

2. The non-transitory computer-readable medium of claim 1, wherein performing the hierarchical fetch to retrieve the set of rules comprises retrieving the most specific rules applicable to the event.

3. The non-transitory computer-readable medium of claim 1, wherein performing the hierarchical fetch to retrieve the set of rules comprises examining the rules in order from most specific to broadest.

4. The non-transitory computer-readable medium of claim 1, wherein performing the hierarchical fetch to retrieve the set of rules comprises examining the rules in order from broadest to most specific.

5. The non-transitory computer-readable medium of claim 4, wherein performing the hierarchical fetch to retrieve the set of rules comprises overriding a broad set of rules with a more specific set of rules.

6. The non-transitory computer-readable medium of claim 1, wherein the computer-executable instructions further comprise computer-executable instructions that cause the computer to:
receive input from the interface, wherein the input comprises information describing the completion of a milestone; and
validate the input using the set of rules.

7. The non-transitory computer-readable medium of claim 1, wherein the set of rules comprises display rules, flow rules, business rules, fulfillment rules, data rules, notification rules, or combinations thereof.

8. The non-transitory computer-readable medium of claim 1, wherein the interface comprises a text field, dropdown list, checkbox, or combinations thereof.

9. The non-transitory computer-readable medium of claim 1, wherein the input is validated using fulfillment rules and business rules.

10. The non-transitory computer-readable medium of claim 1, wherein the computer-executable instructions that cause the computer to validate the input comprises computer-executable instructions that cause the computer to:
determine, using fulfillment rules, the required data for an event; and
determining whether the input contains at least the required data.

11. The non-transitory computer-readable medium of claim 1, wherein the information describing an event comprises information regarding a completed milestone.

12. The non-transitory computer-readable medium of claim 1, wherein performing the hierarchical fetch to retrieve the set of rules comprises applying a filter based on the information describing the event to a database of rules.

13. The non-transitory computer-readable medium of claim 1, further comprising instructions that cause the computer to use flow rules to determine a subsequent milestone.

14. The non-transitory computer-readable medium of claim 1, further comprising instructions that cause the computer to use notification rules to transmit a message corresponding to the completion of a milestone, the failure to complete a milestone, or a delay in the completion of a milestone.

15. A non-transitory computer-readable medium having stored thereon computer-executable instructions which, when executed by a computer, cause the computer to:
receive information describing an event;
retrieve display rules and business rules corresponding to the event;
use the display rules and the business rules to create an interface; and
display the interface.

16. The non-transitory computer-readable medium of claim 15, further comprising instructions that cause the computer to:
retrieve fulfillment rules corresponding to the event;
receive input from the interface, wherein the input comprises information describing the completion of a milestone; and
validate the input using the fulfillment rules.

17. The non-transitory computer-readable medium of claim 15, further comprising instructions that cause the computer to:
retrieve notification rules corresponding to the event; and
use the notification rules to transmit a message.

18. The non-transitory computer-readable medium of claim 15, wherein the display rules and the business rules are retrieved using a hierarchical fetch.

19. A method for managing one or more milestones, comprising:
receiving information describing an event;
creating the one or more milestones based on the event;
retrieving a set of rules corresponding to the event using a hierarchical fetch;
using the set of rules to create an interface corresponding to the one or more milestones; and
displaying the interface.

20. The method of claim 19, further comprising using a portion of the set of rules to transmit a message corresponding to the completion of the one or more milestones, the failure to complete the one or more milestones, or a delay in the completion of the one or more milestones.
